(19) United States
(12) Patent Application Publication
(10) Pub. No.: US 2014/0368935 A1
(43) Pub. Date: Dec. 18, 2014

(54) LENS MODULE

(71) Applicant: SAMSUNG ELECTRO-MECHANICS CO., LTD., Suwon (KR)

(72) Inventor: Sung Won Min, Suwon (KR)

(73) Assignee: SAMSUNG ELECTRO-MECHANICS CO., LTD., Suwon (KR)

(21) Appl. No.: 13/972,662

(22) Filed: Aug. 21, 2013

(30) Foreign Application Priority Data
Jun. 12, 2013 (KR) 10-2013-0067027

(51) Int. Cl. G02B 7/09

(52) U.S. Cl. CPC G02B 7/09
USPC 359/824

(57) ABSTRACT

There is provided a lens module including: an actuator moving a lens barrel in an optical axis direction; and a housing having a mounting part on which the actuator is mounted, wherein the actuator includes a piezoelectric member and a bar member vibrated by the piezoelectric member, and the bar member line-contacts the mounting part.

### CROSS-REFERENCE TO RELATED APPLICATIONS

This application claims the priority of Korean Patent Application No. 10-2013-0067027 filed on Jun. 12, 2013, in the Korean Intellectual Property Office, the disclosure of which is incorporated herein by reference.

### BACKGROUND OF THE INVENTION

1. Field of the Invention

The present invention relates to a lens module, and more particularly, to a lens module in which a lens barrel moves using a smooth impact drive mechanism (SIDM) scheme.

2. Description of the Related Art

A high performance lens module commonly has an autofocus function in order to improve resolution. That is, such a high performance lens module includes an actuator moving a lens barrel in an optical axis direction.

Two types of actuator are mainly used to move a lens barrel. One type thereof has a structure using a permanent magnet and a coil, while the other type has a structure using a piezoelectric member. Here, since the former moves the lens barrel due to a change in magnetic force generated in the coil, the lens barrel may be moved relatively rapidly. However, since a member such as a spring, or the like, for supporting the lens barrel is required, a structure of the lens module may be relatively complicated.

In contrast thereto, since the latter has a comparatively simple structure and may move the lens barrel relatively rapidly, it may be effectively applied to a small lens module. However, in the latter, since it may be difficult to align and fix a position of the actuator with respect to a housing, a tilt phenomenon may occur in the lens barrel due to a mounting defect of the actuator.

As the related art associated with the present invention, there is provided Patent Document 1. Patent Document 1 discloses a structure of fitting and fixing one end of a rod 42 into a hole 526 of a housing 5. However, since the structure disclosed in Patent Document 1 is a structure in which only one end of the rod 42 is slightly fitted into the hole 526 of the housing 5, it is difficult to improve mounting precision of the rod 42 with respect to the housing 5, a tilt phenomenon of the lens barrel may easily occur.

### RELATED ART DOCUMENT

(Patent Document 1) KR2012-088794 A

### SUMMARY OF THE INVENTION

An aspect of the present invention provides a lens module capable of improving mounting precision of an actuator with respect to a housing.

According to an aspect of the present invention, there is provided a lens module including: an actuator moving a lens barrel in an optical axis direction; and a housing having a mounting part on which the actuator is mounted, wherein the actuator includes a piezoelectric member and a bar member vibrated by the piezoelectric member, and the bar member line-contacts the mounting part.

The actuator may further include a mass member coupled to the piezoelectric member.

The mounting part may include: a first mounting part receiving the piezoelectric member therein; and a second mounting part contacting the bar member.

The bar member may have a cylindrical shape.

At least a portion of the mounting part may be a groove having a cross section having an arc shape, and a diameter of the cylindrical shape and a diameter of the arc shape may be different.

At least a portion of the mounting part may be a groove line-contacting the bar member at two points and having a cross section having a polygonal shape.

The bar member may have a polyprismatic shape.

At least a portion of the mounting part may be a groove line-contacting the bar member at two points and having a cross section having an arc shape.

At least a portion of the mounting part may be a groove line-contacting the bar member at two points and having a cross section having a polygonal shape.

The lens module may further include a permanent magnet contacting coupled to the lens barrel and contacting the bar member.

The lens module may further include an adhesive member applied between the mounting part and the bar member.

According to another aspect of the present invention, there is provided a lens module including: a housing receiving a lens barrel therein; an actuator moving the lens barrel in an optical axis direction and including a piezoelectric member and a bar member; and a bracket mounted in the housing and supporting the actuator to be in parallel with the optical axis direction of the lens barrel, wherein the bar member line-contacts the bracket.

The actuator may further include a mass member coupled to the piezoelectric member.

The bracket may include: a first mounting part receiving the piezoelectric member therein; and a second mounting part contacting the bar member.

The bar member may have a cylindrical shape.

The bracket may be provided with a groove having a cross section having an arc shape, and a diameter of the cylindrical shape and a diameter of the arc shape may be different.

The bracket may be provided with a groove line-contacting the bar member at two points and having a cross section having a polygonal shape.

The bar member may have a polyprismatic shape.

The bracket maybe provided with a groove line-contacting the bar member at two points and having a cross section having an arc shape.

The bracket may be provided with a groove line-contacting the bar member at two points and having a cross section having a polygonal shape.

The lens module may further include a permanent magnet contacting coupled to the lens barrel and contacting the bar member.

The lens module may further include an adhesive member applied between the mounting part and the bar member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view of a lens module according to an embodiment of the present invention;

FIG. 2 is an assembled perspective view of a lens barrel and an actuator shown in FIG. 1;

FIG. 3 is an assembled perspective view of a housing and the actuator shown in FIG. 1;

FIG. 4 is a cross-sectional view of a coupling structure of the housing and the actuator taken along line A-A of FIG. 3;

FIGS. 5 through 8 are cross-sectional views of another coupling structure of the housing and the actuator taken along line A-A;

FIG. 9 is a view showing an actuator and a bracket of a lens module according to another embodiment of the present invention; and

FIG. 10 is a cross-sectional view showing a coupling structure of the bracket and a housing shown in FIG. 9.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

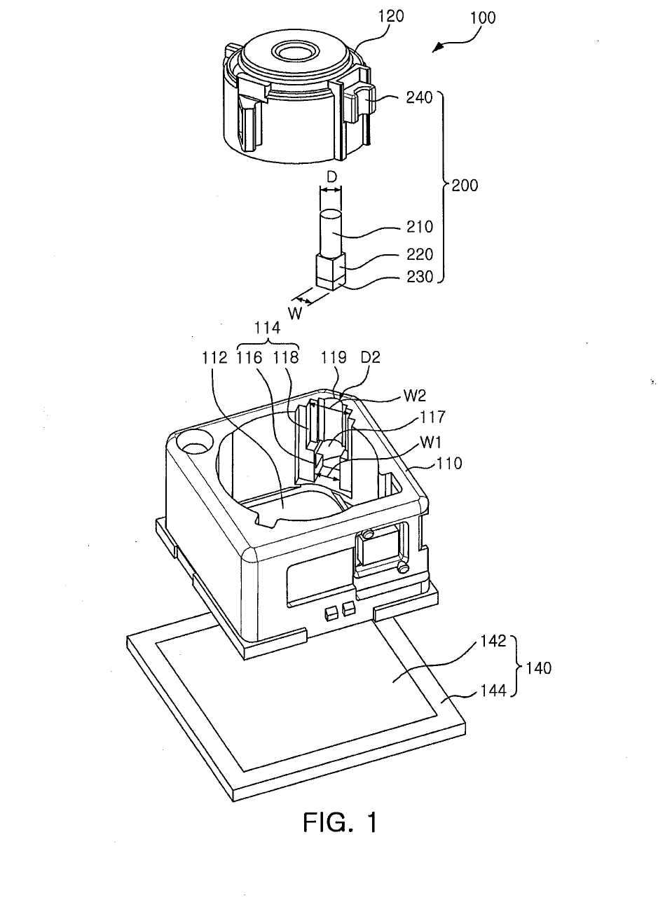

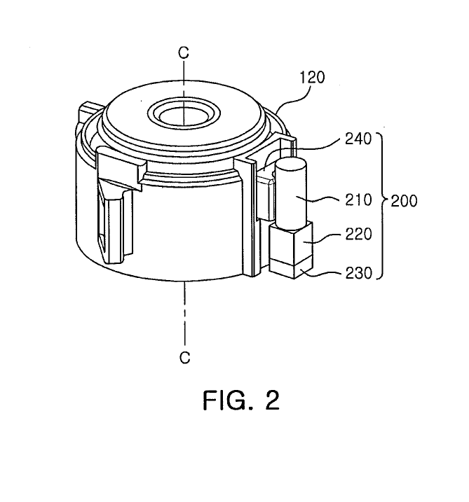

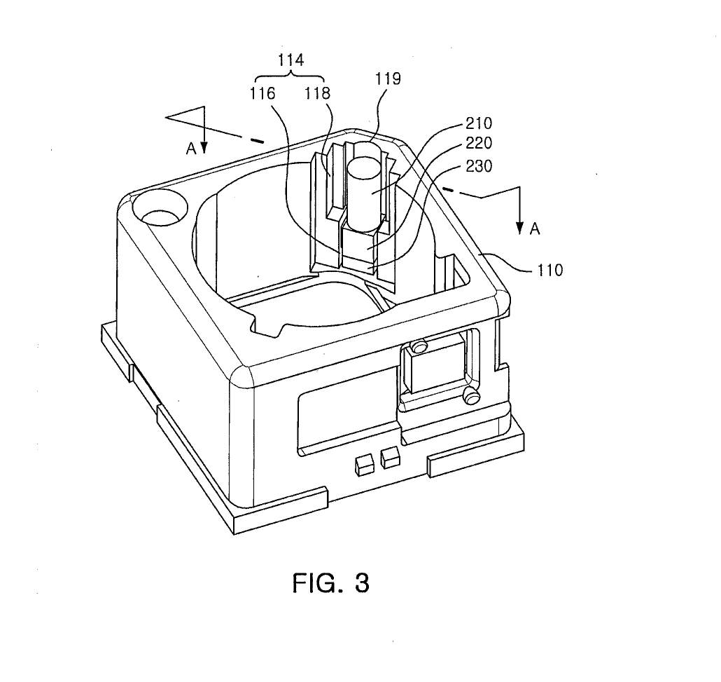

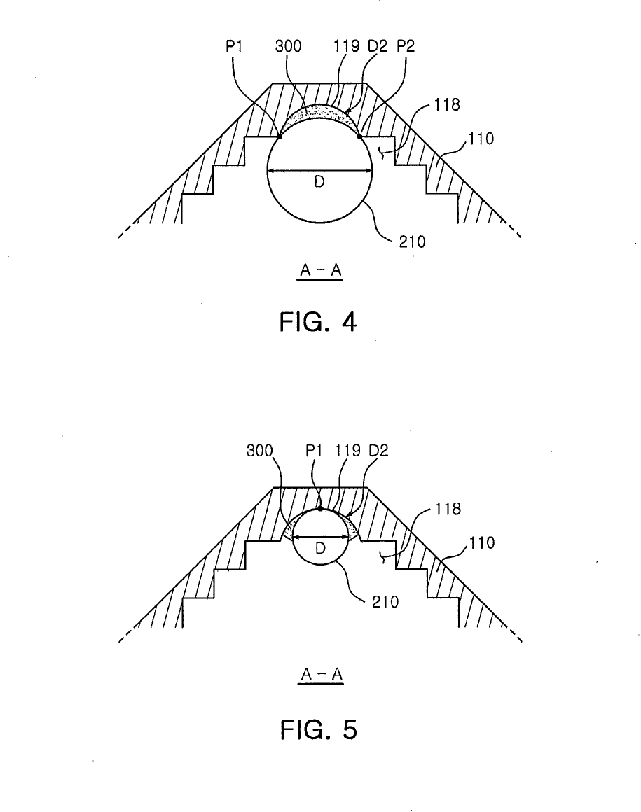

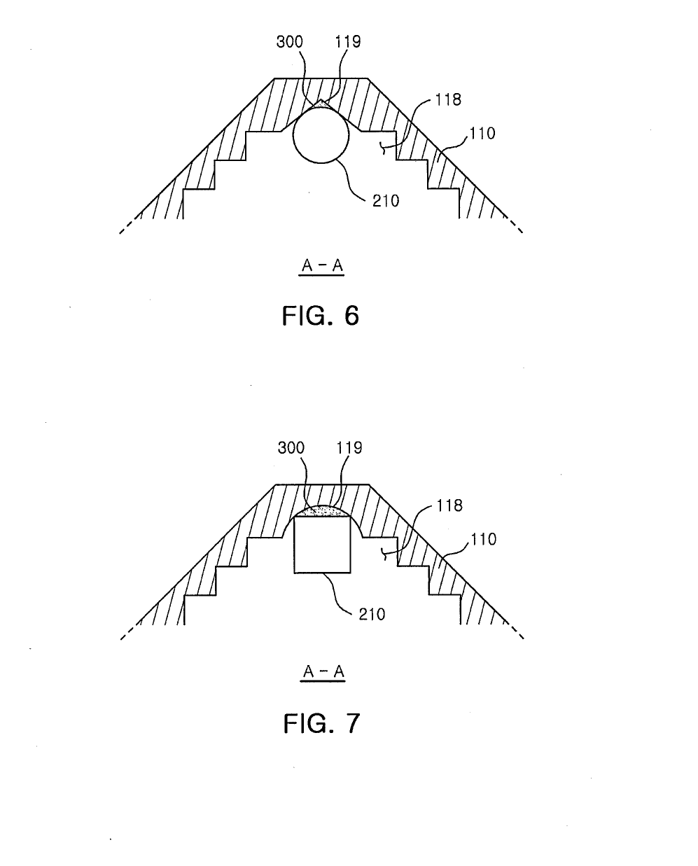

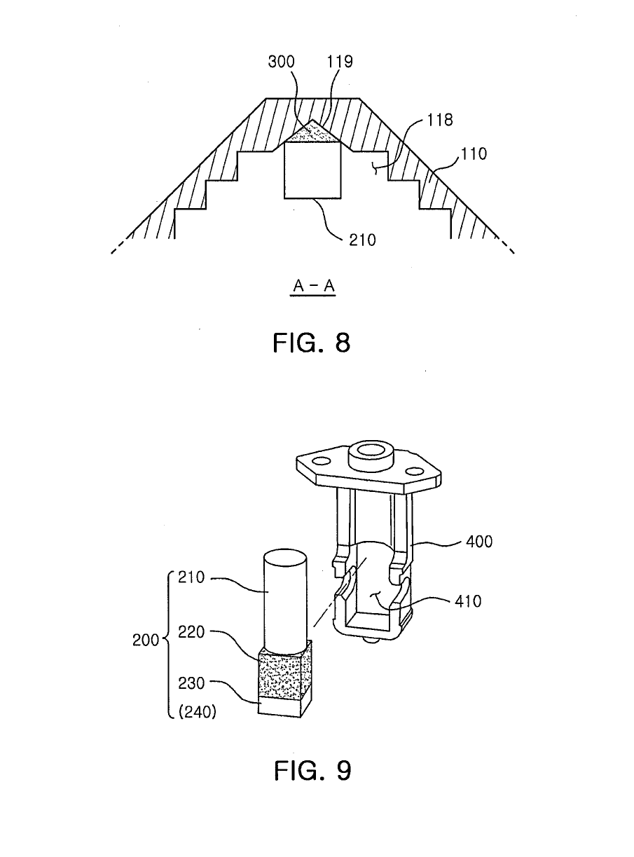

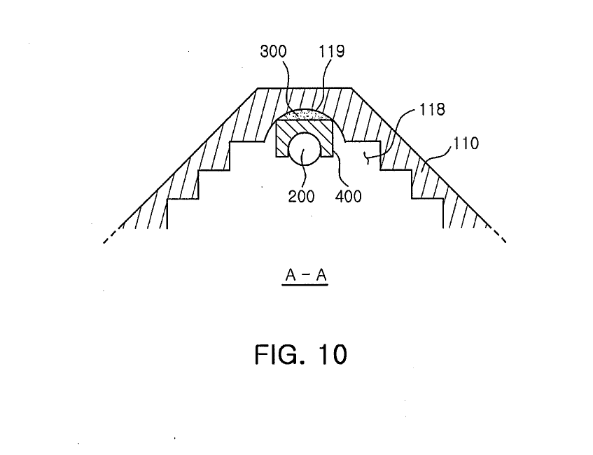

FIG. 1 is an exploded perspective view of a lens module according to an embodiment of the present invention; FIG. 2 is an assembled perspective view of a lens barrel and an actuator shown in FIG. 1; FIG. 3 is an assembled perspective view of a housing and the actuator shown in FIG. 1; FIG. 4 is a cross-sectional view of a coupling structure of the housing and the actuator taken along line A-A of FIG. 3; FIGS. 5 through 8 are cross-sectional views of another coupling structure of the housing and the actuator taken along line A-A; FIG. 9 is a view showing an actuator and a bracket of a lens module according to another embodiment of the present invention; and FIG. 10 is a cross-sectional view showing a coupling structure of the bracket and a housing shown in FIG. 9.

The lens module 100 according to the embodiment of the present invention may include a hosing 110, a lens barrel 120, and an actuator 200 as shown in FIG. 1. In addition, the lens module 100 may further include an image sensor unit 140. In addition, the lens module 100 may further include a shield can. Further, the lens module 100 further may further include an additional component in addition to the above-mentioned components. For example, the lens module 100 may further include a sensor (for example, a hall sensor) sensing a relative position of the lens barrel 120 with respect to an image sensor unit.

The housing 100 may be formed of a material having resistance to external impacts. For example, the housing 110 may be formed of a metal, a plastic, or another material having a predetermined degree of rigidity. However, the housing 110 is not limited to being formed of the above-mentioned material, but may be formed of another material if necessary.

The housing 110 may receive the lens barrel 120 and the actuator 200 therein. More specifically, the housing 110 may be provided with a receiving part 112 receiving the lens barrel 120 therein and a mounting part 114 receiving the actuator 200 therein.

The receiving part 112 may be generally formed at the center of the housing 110. More specifically, the receiving part 112 may be penetrated in a vertical direction with respect to one surface of the image sensor unit 140.

The receiving part 112 may have a transversal cross section larger than that of the lens barrel 120. More specifically, the receiving part 112 may have the transversal cross section larger than that of the lens barrel 120 so that the lens barrel 120 received therein may move in a vertical direction (hereinafter, referred to as an alignment direction) of an optical axis to be actively aligned. However, the transversal cross section of the receiving part 112 is not necessarily larger than that of the lens barrel 120. That is, the receiving part 112 and the lens barrel 120 may have the same cross sectional size if necessary.

The mounting part 114 may be formed at an edge adjacent to the receiving part 112. For example, the mounting part 114 may be formed at an edge of the housing 110 as shown in FIG. 1. When the mounting part 114 is formed at the edge of the housing 110 as described above, space utilization efficiency of the housing 110 is increased to thereby be advantageous for miniaturization of the lens module 100.

The mounting part 114 may include a first mounting part 116 and a second mounting part 118.

The first mounting part 116 may receive a piezoelectric member 220 and a mass member 230 of the actuator 200 therein. Here, the first mounting part 116 may have a width W1 greater than a width W of the piezoelectric member 220. The above-mentioned condition may enable free movement of the piezoelectric member 220 disposed at the first mounting part 116. However, the width W1 of the first mounting part 116 and the width W of the piezoelectric member 220 may be the same as each other as long as the piezoelectric member 220 may be freely moved. In addition, the first mounting part 116 may be provided with a hole 117 opened to the outside of the housing 110. The hole 117 may be used as a space for withdrawing a flexible substrate connected to the piezoelectric member 220.

The second mounting part 118 may receive a bar member 210 of the actuator 200 therein. Here, the second mounting part 118 may have a width W2 greater than a diameter D of the bar member 210. Therefore, the bar member 210 received in the second mounting part 118 may not contact a side of the second mounting part 118. In addition, the second mounting part 118 may be provided with a groove 119 lengthily extended in a height direction of the housing 110. The groove 119 may have a cross section having an arc shape. Here, the arc shape may have a diameter D2. However, a shape of the cross section of the groove 119 is not limited to the arc shape, but may have another shape if necessary. The groove 119 may contact the bar member 210. More specifically, the groove 119 may line-contact the bar member 210 through one or more segment lengthily extended in the height direction of the housing 110. The contact structure between the groove 119 and the bar member 210 as described above may be advantageous in aligning the bar member 210 in parallel with the height direction of the housing 110.

The lens barrel 120 may include one or more lens. More specifically, the lens barrel 120 may include one or more lens for projecting light reflected from a subject to the image sensor unit 140. Here, optical characteristics of the lens may be determined depending on a type of lens module 100. For example, a high resolution lens module 100 may include four or more lenses, and a low resolution lens module 100 may include three or less lenses. In addition, the lens barrel 120 may further include a stop adjusting an amount of incident light and a filter cutting off infrared rays.

An inner surface of the lens barrel 120 may be coated with an anti-reflective material or a light shielding material. This configuration may decrease a phenomenon in which unnecessary light is reflected onto the inner surface of the lens barrel 120 to be incident to the image sensor unit, whereby resolution of the lens module 100 may be improved.

The image sensor unit 140 may include an image sensor 142 and a substrate 144. In addition, the image sensor unit 140 may further include one or more electronic component (for example, a passive device) required for driving the image sensor 142. Here, the image sensor 142 may be a charge coupled device (CCD) or complementary metal oxide semiconductor (CMOS) type electronic component. However, the image sensor 142 is not limited to the above-mentioned type of electronic component, but may be another type of electronic component. The substrate 144 may include a circuit pattern enabling an electrical connection between the image sensor 142 and the passive device. In addition to the passive device, the substrate 144 may further include other electronic components making an operation of the image sensor 142 relatively smooth. Meanwhile, the image sensor 142 and the passive device may be formed integrally with each other on the substrate 144. For example, the image sensor 142 may be manufactured in a chip scale package (CSP) form.

Next, the actuator 200 will be described with reference to FIGS. 1 and 2.

The actuator 200 may include the bar member 210, the piezoelectric member 220, the mass member 230, and a magnet member 240.

The bar member 210 may generally have a cylindrical shape. More specifically, the bar member 210 have a cylindrical shape in which it has a diameter D. Here, the diameter D may be different from a diameter D2 of the groove 119 having an arc shape. For reference, although the case in which the bar member 210 has the cylindrical shape has been described in the present embodiment, the bar member 210 is not limited to having the cylindrical shape. For example, the bar member 210 may have another shape as long as it may transfer vibrations of the piezoelectric member 220 to the lens barrel 120 or the magnet member 240. For example, the bar member 210 may be manufactured to have a prismatic shape.

The bar member 210 may contact the magnet member 240. More specifically, the bar member 210 may be closely adhered to the magnet member 240 by magnetic force. Therefore, the bar member 210 may be formed of a ferromagnetic substance easily affected by magnetic force. However, the bar member 210 is not limited to being formed of the ferromagnetic substance, but may be formed of another material if necessary. For example, the bar member 210 may be formed of a non-magnetic material.

The piezoelectric material 220 may be attached to one end of the bar member 210 and provide substantial driving force enabling movement of the lens barrel 120. More specifically, the piezoelectric member 220 may vibrate the bar member 210 in a length direction while being repeatedly expanded or contracted and bent depending on a current signal, and the vibrations of the bar member 210 may move the lens barrel 120 in an optical axis direction C-C. Here, a direction in which the lens barrel 120 is moved may be changed depending on a movement pattern of the piezoelectric member 220 vibrating the bar member 210.

The mass member 230 may be formed at one end of the piezoelectric member 220. More specifically, the mass body 230 may be positioned at an opposite side to the bar member 210 based on the piezoelectric member 220. The mass member 230 formed as described above may provide directionality and stability to driving force of the piezoelectric member 220.

The magnet member 240 may be coupled to the lens barrel 120. More specifically, the magnet member 240 may be firmly attached to a side of the lens barrel 120. The magnet member 240 configured as described above may increase close adhesion between the lens barrel 120 and the actuator 200 to transfer the driving force by the actuator 200 to the lens barrel 120. For reference, one surface of the magnet member 240 may be provided with a groove to which the bar member 210 having the cylindrical shape may be closely adhered.

Next, a coupling structure between the actuator 200 and the housing 110 will be described with reference to FIGS. 3 and 4.

The actuator 200 may be mounted at the mounting parts 116 and 118 of the housing 110. More specifically, the actuator 200 may be aligned by the bar member 210 contacting the second mounting part 118.

The contact between the bar member 210 and the second mounting part 118 may be stably maintained in a state in which a contact area therebetween is maximized. That is, the bar member 210 having the cylindrical shape and the second mounting part 118 in which the groove 119 is formed may be maintained in the most stable state when they line-contact each other at two points P1 and P2 as shown in FIG. 4. (For reference, in a state other than the above-mentioned state, since the bar member 210 and the second mounting part 118 point-contact each other, they may not be maintained in a stable state of contact). Particularly, since the bar member 210 and the second mounting part 118 line-contact each other by the segment that is in parallel with the height direction of the housing 110, the contact between the bar member 210 and the second mounting part 118 may align the actuator 200 to be in parallel with the height direction of the housing 110. Therefore, according to the present embodiment, the alignment of the actuator 200 may be enabled only by mounting the actuator 200 at the mounting parts 116 and 118.

The bar member 210 and the groove 119 of the second mounting part 118 may have an adhesive 300 filled therebetween. More specifically, when the mounting of the actuator 200 is completed, the adhesive 300 may be filled in a gap between the bar member 210 and the groove 119 in order to improve reliability of coupling between the housing 110 and the actuator 200. Here, as the adhesive 300, a photocurable resin adhesive, a thermosetting resin adhesive, or the like, may be used. However, the adhesive 300 is not limited to the above-mentioned kind of adhesive, but may be another kind of adhesive if necessary.

Meanwhile, a form in which the bar member 210 and the second mounting part 118 contact each other may be changed as shown in FIGS. 5 and 6. For example, the bar member 210 and the second mounting part 118 may line-contact each other at one point P1 as shown in FIG. 5. In this case, the bar member 210 may have a diameter D smaller than a diameter D2 of the groove 119. In addition, the second mounting part 118 may have a cross section having a shape other than the arc shape, as shown in FIG. 6. In this case, the bar member 210 having a circular cross section and the groove 119 may easily line-contact each other.

In addition, the bar member 210 may have a cross section having a shape other than the circular shape, as shown in FIGS. 7 and 8. For example, the bar member 210 may have a cross section having a rectangular shape, as shown in FIGS. 7 and 8. The bar member 210 having the above-mentioned shape may be more easily processed as compared with a bar member having a cylindrical shape. In addition, since the bar member 210 having the above-mentioned shape has the same cross sectional shape as that of the piezoelectric member 220, it may be easily coupled to and aligned with the piezoelectric member 220.

Next, a lens module according to another embodiment of the present invention will be described with reference to FIGS. 9 and 10.

The lens module according to the present embodiment may further include a bracket 400. More specifically, the lens module according to the present embodiment may include the bracket 400 receiving the actuator 200 therein as shown in FIG. 9.

The bracket 400 may have an internal space 410 capable of receiving the actuator 200 therein and be mounted at the mounting part 114 of the housing 110. Here, the bracket 400 may line-contact the mounting part 114 as shown in FIG. 10. In addition, the bracket 400 and the groove 119 may have an adhesive 300 filled therebetween in order to improve reliability of coupling therebetween.

In the lens module configured as described above, since the bracket 400 protects the actuator 200 from external impacts, reliability of an operation of the actuator 200 may be improved.

As set forth above, according to the embodiments of the present invention, since the actuator may be precisely mounted in the housing, a tilt phenomenon of the lens barrel generated in a process of mounting the lens barrel may be significantly decreased.

While the present invention has been shown and described in connection with the embodiments, it will be apparent to those skilled in the art that modifications and variations can be made without departing from the spirit and scope of the invention as defined by the appended claims.

What is claimed is:

1. A lens module comprising:
an actuator moving a lens barrel in an optical axis direction; and
a housing having a mounting part on which the actuator is mounted,
wherein the actuator includes a piezoelectric member and a bar member vibrated by the piezoelectric member, and
the bar member line-contacts the mounting part.

2. The lens module of claim 1, wherein the actuator further includes a mass member coupled to the piezoelectric member.

3. The lens module of claim 1, wherein the mounting part includes:
a first mounting part receiving the piezoelectric member therein; and
a second mounting part contacting the bar member.

4. The lens module of claim 1, wherein the bar member has a cylindrical shape.

5. The lens module of claim 4, wherein at least a portion of the mounting part is a groove having a cross section having an arc shape, and
a diameter of the cylindrical shape and a diameter of the arc shape are different.

6. The lens module of claim 4, wherein at least a portion of the mounting part is a groove line-contacting the bar member at two points and having a cross section having a polygonal shape.

7. The lens module of claim 1, wherein the bar member has a polyprismatic shape.

8. The lens module of claim 7, wherein at least a portion of the mounting part is a groove line-contacting the bar member at two points and having a cross section having an arc shape.

9. The lens module of claim 7, wherein at least a portion of the mounting part is a groove line-contacting the bar member at two points and having a cross section having a polygonal shape.

10. The lens module of claim 1, further comprising a permanent magnet contacting coupled to the lens barrel and contacting the bar member.

11. The lens module of claim 1, further comprising an adhesive member applied between the mounting part and the bar member.

12. A lens module comprising:
a housing receiving a lens barrel therein;
an actuator moving the lens barrel in an optical axis direction and including a piezoelectric member and a bar member; and
a bracket mounted in the housing and supporting the actuator to be in parallel with the optical axis direction of the lens barrel,
wherein the bar member line-contacts the bracket.

13. The lens module of claim 12, wherein the actuator further includes a mass member coupled to the piezoelectric member.

14. The lens module of claim 12, wherein the bracket includes:
a first mounting part receiving the piezoelectric member therein; and
a second mounting part contacting the bar member.

15. The lens module of claim 12, wherein the bar member has a cylindrical shape.

16. The lens module of claim 15, wherein the bracket is provided with a groove having a cross section having an arc shape, and
a diameter of the cylindrical shape and a diameter of the arc shape are different.

17. The lens module of claim 15, wherein the bracket is provided with a groove line-contacting the bar member at two points and having a cross section having a polygonal shape.

18. The lens module of claim 12, wherein the bar member has a polyprismatic shape.

19. The lens module of claim 18, wherein the bracket is provided with a groove line-contacting the bar member at two points and having a cross section having an arc shape.

20. The lens module of claim 18, wherein the bracket is provided with a groove line-contacting the bar member at two points and having a cross section having a polygonal shape.

21. The lens module of claim 12, further comprising a permanent magnet contacting coupled to the lens barrel and contacting the bar member.

22. The lens module of claim 12, further comprising an adhesive member applied between the mounting part and the bar member.
